(19) United States
(12) Patent Application Publication
(10) Pub. No.: US 2004/0203613 A1
(43) Pub. Date: Oct. 14, 2004

(54) Mobile terminal

(75) Inventors: Houtao Zhu, Yokohama (JP); Theodore Buot, Windsor Gardens (AU); Rin Nagaike, Shinjyuku-ku (JP)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 10/164,677

(22) Filed: Jun. 7, 2002

(51) Int. Cl. H04M 11/10; H04M 3/42

(52) U.S. Cl. 455/412.1; 455/413; 455/414.1

(57) ABSTRACT

A mobile terminal comprising an address book for registering identification numbers of the persons who exchange messages with the user of the mobile terminal, a memory for storing a received text message, and a conversion engine for converting the stored message to a voice message. The mobile terminal sequentially reads the text message stored in the memory and converts the text message to the voice message using the conversion engine for output. The address book stores a voice characteristic code of the person associated with each identification number, and the conversion engine converts the text message to the voice message using the voice characteristic code. The mobile terminal thus converts a text message to a voice message having the characteristics of the voice of the person who sent the text message for subsequent output.

### BACKGROUND OF THE INVENTION

1. Field of the Invention

The present invention relates to a mobile terminal such as a mobile telephone, particularly, a mobile terminal which can receive a text message such as an e-mail and convert it to a voice message for output.

2. Description of the Related Art

Recent mobile telephones are provided with capability of receiving text messages such as e-mail and short message service (SMS). The received text message is first stored in the memory incorporated in the mobile terminal, then read by the person who received the message and shown on the display of the mobile telephone. However, generally, the mobile telephone has such small display that the user cannot conveniently read the message especially when the message is long. Therefore, a mobile telephone has been developed which incorporates a conversion engine to convert a text message to a voice message. Such mobile telephone converts the received text message to a voice message for output from an incorporated speaker, at reading. This type of mobile telephone is very convenient in that the user can reproduce a text message such as an e-mail and SMS message as a voice message, regardless of the size of the mobile telephone display.

However, the conversion engine of the existing mobile telephone reproduces all the text messages in plain machine sound without reflecting characteristics of the sender of the text message. Therefore, the person who received the message cannot identify the person who sent the message.

### SUMMARY OF THE INVENTION

The purpose of the invention is to solve this problem by providing a mobile terminal that can convert a text message to a voice message for output, wherein the terminal can output a voice message having the characteristics of the voice of the sender of the text message. The invention also provides a mobile terminal which can apply various modifications to a voice message and output the voice message with different sound quality.

According to the invention, a mobile terminal contains an address book for registering identification numbers of the persons who exchange messages with the user of the mobile terminal, a memory for storing a received text message, and a conversion engine for converting the stored message to a voice message. The mobile terminal sequentially reads the text message stored in the memory and converts the text message to the voice message using the conversion engine for output. The address book stores a voice characteristic code associated with the identification number, and the conversion engine converts the text message to the voice message using the voice characteristic code provided.

According to another aspect of the invention, the mobile terminal can store voice characteristic codes not corresponding to any identification number.

According to another aspect of the invention, the mobile terminal can store added-value data which can be used for modifying the voice characteristic code. The above added-value data can be input manually by a user.

The voice characteristics code can be obtained from other devices or by inputting the original voice of a person associated with the identification number into the mobile terminal.

Alternatively, the voice characteristics code can be obtained by accessing a site of the person associated with the identification number, and downloading and registering in the address book in the terminal.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1 shows a construction of an address book used in the invention; and

FIG. 2 illustrates a method to reproduce a voice message in accordance with the invention.

### DETAILED DESCRIPTION OF THE PRESENTLY PREFERRED EMBODIMENTS

A preferred embodiment of the invention which is incorporated in a mobile telephone will be described. Generally, a mobile telephone is provided with an address book which stores the telephone numbers and e-mail addresses of the persons who exchange messages with the user. That is, the address book stores a plurality of identification numbers of callers (hereinafter referred to as “caller ID”). At sending, the sender can retrieve any caller ID and send a message thereto. At receiving, the receiving party can check the ID of the received message against the caller IDs in the address book to identify the sender of the message. According to the invention, the voice characteristics codes (hereinafter referred to as “voice code”) of the senders are stored in association with the caller IDs in the address book which registers and stores these caller IDs.

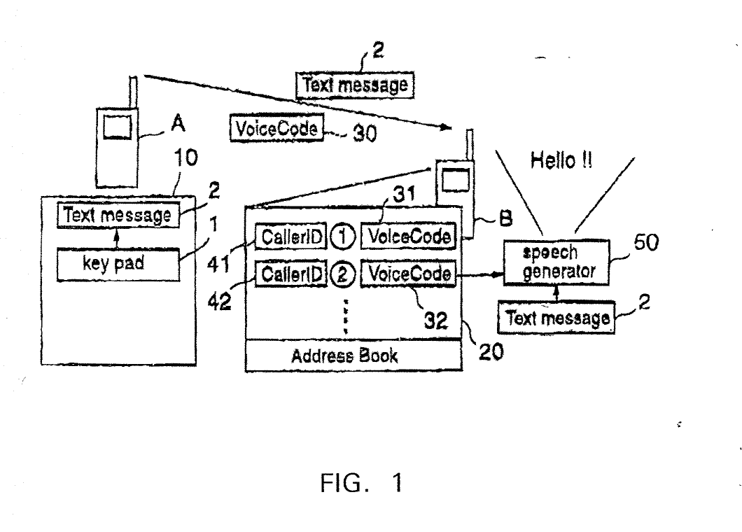

FIG. 1 shows the construction of an address book used in the invention. As described, the address book 20 used in the invention stores caller IDs 41, 42, . . . , and the voice codes 31, 32, . . . , respectively associated with each caller ID.

The voice code is the data representing the characteristics of the voice of the person having the corresponding caller ID. The conversion engine of the mobile telephone associates the voice code with the text message to be converted. Thus, the reproduced voice message will be bestowed with characteristics represented by the voice code, i.e., the voice of the sender of the message can be reproduced. The voice code is generated by analyzing the characteristics of the voice of a person, for example, a general young woman or a typical old man. But it can also be generated by extracting the characteristics of the voice of the specific person, for example, his friend or his wife. The address book 20 can store several voice codes associating with respective caller IDs. In a preferred embodiment, a caller ID is associated with unique voice code in the address book 20.

The speech generator 50 driven by the conversion engine selects the voice code associated with the caller ID of the sender of the message when it reads the text message, and performs text/voice conversion using the selected voice code to output the voice message which has sound quality similar to that of the sender.

The operation of the invention will be described with reference to FIG. 1. First, a case wherein a text message is sent from the sending telephone A to the receiving telephone B, and the message is received and converted to a voice message at telephone B will be described.

First, a person generates a text message to be sent using a keypad 1 at the sending telephone 10. The generated text message is stored in the predefined memory, and sent to the receiving telephone B by the sending operation of the telephone A. The address book 20 of the receiving telephone B stores the voice codes 31, 32, . . . , respectively associated with the caller IDs 41, 42, . . . , as described.

These caller IDs may be telephone numbers and/or e-mail addresses. Upon receipt, the receiving telephone B identifies the sender of the message by checking the telephone number and/or e-mail address of the message against the telephone numbers and/or e-mail addresses stored in the address book of the telephone B, to verify if the received message's caller ID is stored in the address book 20.

When the caller ID is stored in the address book 20, the voice code associated with the caller ID and stored in the address book is retrieved. The text message 2 received by the receiving telephone is stored in the predefined memory. The telephone reads the text message by specifying the text message with predefined operations and activating the conversion engine. At this time, the voice code 32 associated with the caller ID of the text message 2 is read simultaneously, and supplied to the speech generator 50. The speech generator 50, in turn, uses the voice code 32 when reproducing the text message 2.

The speech generator 50 generates a voice message in sound having characteristics of the voice of the sender of the text message. The voice code representing various characteristics can be generated by known voice recognition technologies. The voice code 30 may be generated in advance and sent/received via e-mail or other methods. The receiving telephone B may receive the voice code 30 and store it in the address book 20, in advance.

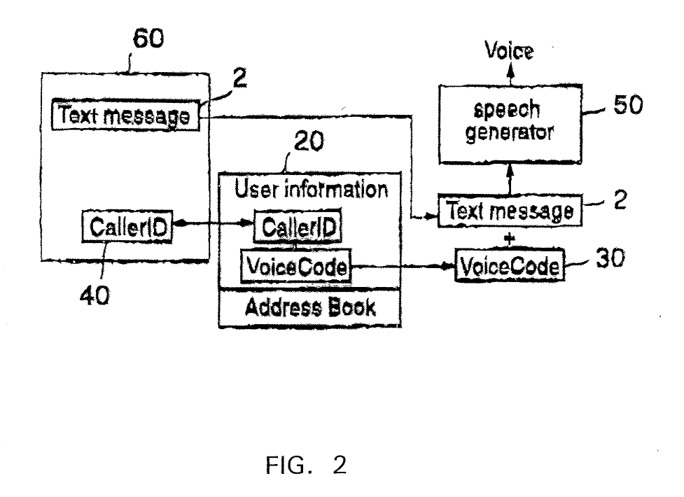

FIG. 2 shows the detailed operation in which the text message is received and converted to a voice message at the receiving telephone.

The receiving telephone 60 stores the received text message in the predefined memory area. The receiving telephone 60 recognizes the caller ID 40 of the text message 2 at reception. The receiving telephone 60 reads the caller ID 40 of the received text message 2 from the memory when it reads the text message, and checks the caller ID 40 against the caller IDs stored in the address book 20. That is, the receiving telephone 60 verifies if the caller ID of the received message is already registered in the address book 20.

When it determines that the ID 40 is registered in the address book 20, it reads the voice code 30 which is registered in association with the caller ID 40. The voice code 30 and the text message stored in the memory area of the receiving telephone 60 are supplied to the speech generator 50. The speech generator 50 converts the text message to a voice having the characteristics of the voice of the person who sent the text message, and outputs the voice.

To implement the invention, the mobile telephone must incorporate the following software components and/or the hardware component in advance:

An address book which stores the caller IDs and associated voice codes has to be incorporated in the mobile telephone as a plug-in software component;

A conversion engine which converts a text message to a voice message must be incorporated as a plug-in software component; and

A speech generator which converts a message obtained by using this conversion engine must be incorporated as a software component or a hardware component.

Next, the voice code used in the invention will be described.

The voice code is a set of characteristic data of a voice, and must contain the characteristics sufficient to identify the sender of the text message, when the mobile telephone converts a text message to a voice message for reproduction. Generally, human voice has distinct characteristics which can be extracted and used to identify it. The technique to extract these characteristics for personal identification is known as voice recognition technology. Voice is a combination of sound signals having a plurality of frequencies, so that it can be converted into frequency data comprising frequency and amplitude by using time-frequency transformation technology, like Fast Fourier Transformation (FFT). Such a voice code itself is widely used for text-voice conversion technology. The voice code is stored in the address book 20, and later used to reproduce the voice.

If another voice code representing some characteristics of a person including sex, age, sound quality, and accent is additionally prepared, such added-value voice code can be used as added-value data in reproducing the voice of a specific person. The original voice of the person can be modified using this added-value data. For example, a basic voice data may be a set of frequency and amplitude distribution, and added-value data may be generated representing the certain characteristics of the person, for example, a man, 34 years old, having high-pitched voice with a particular accent. The basic voice is reproduced from the basic data, and then, the voice can be modified by applying the added-value data to the basic voice.

As described, the added-value data can be used to provide features similar to a voice changer used in “Karaoke” apparatus. The added-value data may be input manually by the user using a keypad. The added-value data may be stored in the address book in advance, and added to the basic voice when the received text data is converted to a voice data for output, in order to reproduce a voice closer to the voice of the sender of the text message.

It should be noted that the use of the added-value data is not essential to the invention. Also, the added-value data can be manually input by the user, as described, but it can be obtained by accessing relevant sites, as well. Furthermore, the added-value data can be stored in the mobile telephone in advance.

Thus, the added-value data can be used for modifying the voices in various ways, which provides a variety of application for the resulting voice.

The voice code should be generated by special device for extracting sound characteristics. Because, a powerful computing machine is required to extract voice characteristics with enough high quality. After generated, the voice code is transferred and stored to the mobile terminal by wireless communications, for example, Bluetooth, WLAN, or cellular network. When a mobile terminal is equipped with a very powerful device for voice characteristic extraction, a voice code might be generated directly by a mobile terminal.

In another embodiment, a voice code can be a set of sound data which represent characters or words. The sound data corresponding to each character is stored as a sound database. The sound database combines sounds to make each character or word. When the received text message is reproduced, the sound data of characters or words in the text are extracted from the database. Then, the characters or words are synthesized into words or sentences to reproduce the text message.

When the text message is reproduced in the voice of the sender of the message in accordance with the invention, the speech generator reads the corresponding voice code from the address book. Then the basic voice can be reproduced from the voice code by using the conversion engine and the reverse FFT analyzer incorporated in the mobile telephone.

The reproduced basic voice can be modified by applying the added-value data. That is, by adding some characteristics of each person such as his accent to the basic voice, the basic pattern can be modified to represent a voice closer to the sender of the message. When the voice of the sender of the message cannot be reproduced due to limited hardware, a voice code not associated with respective caller ID can be stored as a default voice code, and can be used for reproduction of the voice. Such default voice code can also be used to output a voice message from a text message which is sent from a person not registered in the address book.

As described with reference to specific embodiments, the invention can convert a text message to a voice message in the voice of the sender of the text message by preparing a voice code associated with each caller ID and storing the voice code in the address book in advance. The invention may be conveniently applied to chat communication in which many people speak to each other, as users can identify each speaker. Also, the invention can be applied to various entertainment services. For example, text messages can be reproduced in the voice of a specific person. A user can enjoy hearing a text read in the voice of his favorite movie star. Furthermore, as the voice code is stored as information to identify the sender of the message, it can be used security information.

Thus, while there have been shown and described and pointed out fundamental novel features of the present invention as applied to a preferred embodiment thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

What is claimed is:

1. A mobile terminal comprising an address book for registering identification numbers of the persons who exchange messages with the user of the mobile terminal, a memory for storing a received text message, and a conversion engine for converting the stored message to a voice message, the mobile terminal sequentially reading the text message stored in the memory and converting the text message to the voice message using the conversion engine for output, wherein:
the address book stores a voice characteristic code associated with the identification number; and
the conversion engine converts the text message to a voice message using the voice characteristic code.

2. The mobile terminal of claim 1, wherein the voice characteristic codes not corresponding to said identification numbers are stored.

3. The mobile terminal of claim 1, wherein added-value data which can be used for modifying the voice characteristic code is stored.

4. The mobile terminal of claim 2, wherein added-value data which can be used for modifying the voice characteristic code is stored.
